(19) United States
(12) Patent Application Publication
(10) Pub. No.: US 2016/0006069 A1
(43) Pub. Date: Jan. 7, 2016

(54) Housing for a Fuel Cell Stack

(71) Applicant: DAIMLER AG, Stuttgart (DE)

(72) Inventors: Stefan GERHARDT, Schlierbach (DE); Cosimo MAZZOTTA, Ulm (DE); Joachim SEITZ, Neu-Ulm (DE); Quentin MORIN, Esslingen am Neckar (DE); Alfred HAUG, Kirchheim (DE); Christian SCHICK, Wendlingen (DE)

(73) Assignee: Daimler AG, Stuttgart (DE)

(21) Appl. No.: 14/654,410

(22) PCT Filed: Nov. 14, 2013
(86) PCT No.: PCT/EP2013/003425

§ 371 Date: Jun. 19, 2015

(30) Foreign Application Priority Data
Dec. 20, 2012 (DE) 10 2012 024 964.0

(51) Int. Cl. H01M 8/24

(52) U.S. Cl. CPC H01M 8/2475

(57) ABSTRACT

A housing for a fuel cell stack is disclosed. At least one wall has, at least in some sections, a structure which reinforces the wall. At least in a region with a reinforcing structure, at least one fastening point is formed for fastening at least one fuel cell system component and/or for supporting the housing in an installation space.

### BACKGROUND AND SUMMARY OF THE INVENTION

The invention relates to a housing for a fuel cell stack, wherein at least one wall has, at least in some regions, a structure which reinforces the wall.

A pipe branching device for a fuel cell is known from US 2006/0060244 A1, wherein the pipe branching device has at least one pipe connection with an oversized opening which is delimited by a frame-like distributor pipe. The pipe connection is movable in at least one plane relative to the oversized opening for reducing position-related tolerance requirements of the pipe connection. The pipe branching device is provided in particular for fastening components of a fuel cell system to an end plate.

Furthermore a so-called stack box is known from the prior art as a housing for a fuel cell stack, the housing having a ribbed structure at least in some regions.

The object of the invention is to provide a housing for a fuel cell stack which is improved by comparison with the prior art.

In a housing for a fuel cell stack at least one wall has at least in some regions a structure which reinforces the wall, wherein it is provided according to the invention that at least in a region with a reinforcing structure at least one fastening point is formed for fastening at least one fuel cell system component and/or for supporting the housing in an installation space.

Because on the one hand the at least one wall has the structure which reinforces this wall at least in some regions and on the other hand the at least one fastening point for fastening at least one fuel cell system component and/or for supporting the housing is disposed in the region of the reinforcing structure, both the fuel cell stack and also the at least one fuel cell system component fastened to the fastening point are protected during deformation of the housing against damage resulting from the deformation.

If the housing is supported by means of the fastening point in an installation space, in particular an engine compartment, the support point is likewise largely protected against deformation by the reinforcing structure in this region.

In particular the housing for the fuel cell stack is provided to be disposed in an engine compartment of a motor vehicle, wherein the housing is stiffened by means of the reinforcing structure at least in some regions, so that the risk of a deformation of the housing is at least reduced at least in this region.

The housing preferably has a plurality of regions with a reinforcing structure, so that the housing can be disposed without design-related modifications in different installation spaces which are available and also in installation spaces of different shapes, and can be fastened by means of the fastening point or points.

In particular the housing is box-shaped with a reinforcing structure, so that the housing has a comparatively high rigidity whilst at the same time having a low weight.

In a preferred embodiment the reinforcing structure is formed as ribs having a honeycomb shape and/or a square shape. Advantageously the reinforcing structure extends completely over all the walls of the housing, so that protection of the fuel cell stack against damage, in particular by deformation of the housing, is substantially increased.

In one possible embodiment the at least one fastening point is designed as a formation projecting from a wall, so that advantageously at least one fuel cell system component can be fastened to this projecting formation. Additionally or alternatively the housing can advantageously be fastened in its installation space by means of the projecting formation.

In a further preferred embodiment at least one fastening element is or can be disposed on the at least one fastening point, wherein the fastening point, for example in the form of the projecting formation, serves as a seat for the fastening element. Thus, for example, a through hole, in which a fastening element designed as a screw can be disposed, can be introduced into the projecting formation. It is also conceivable that the fastening point is formed in such a way that a fastening element can be fastened thereon by positive engagement, wherein such a fastening element may, for example, be a clip.

In an advantageous manner the housing is made of metal and/or at least one fiber-reinforced plastic, the housing advantageously being produced as so-called lightweight construction. An aluminum and/or magnesium alloy and/or fiber-reinforced plastic are particularly suitable materials for this purpose. Since the housing is produced as a lightweight construction the weight of the housing is comparatively low, so that, for example, handling for installation of the housing in its installation space can be simplified.

Particularly preferably the housing can be closed by means of a housing cover in which at least one device of the fuel cell system is integrated. Because the housing can be closed by means of the housing cover, the fuel cell stack disposed in the housing is completely surrounded and thus protected against damage. Moreover because at least one device of the fuel cell system, for example a device for conveying media, is integrated in the housing cover, the fuel cell system is designed to save installation space, wherein an available installation space is optimally used by means of the housing cover.

Also in an advantageous manner it may be provided that the housing cover has at least one fastening point for fastening further fuel cell system components. In this way the fuel cell system is designed to be compact, all necessary and separate fuel cell system components preferably being disposed or also integrated on the housing and/or the housing cover.

The walls and/or the housing cover are/is preferably designed at least in part to be electrically insulating, so that an insulating section can be formed by means of the housing. A cost-effective solution is offered by the formation of an insulating section by means of the housing itself, since no further components are necessary for the electrical insulation.

Furthermore it is advantageously possible for the walls and/or the housing cover to be designed at least in part to be thermally insulating. If the housing is designed to be thermally insulating, heat management of the fuel cell stack is considerably improved, wherein the thermal insulation by means of the housing, in particular with regard to a cold starting capability of the fuel cell system, is advantageous.

Fuel cell system components disposed in the housing are advantageously thermally coupled to the fuel cell stack, so that likewise the cold starting capability is improved.

Embodiments of the invention are explained in greater detail below with reference to the drawings.

### BRIEF DESCRIPTION OF THE DRAWINGS

FIG. 1 shows schematically a perspective view of a housing for a fuel cell stack,

FIG. 2 shows schematically a perspective view of the housing with a partially inserted fuel cell stack and housing cover disposed thereon, and

FIG. 3 shows schematically a perspective view of the housing in the closed state.

### DETAILED DESCRIPTION OF THE DRAWINGS

Parts which correspond to one another are provided with the same reference numerals in all drawings.

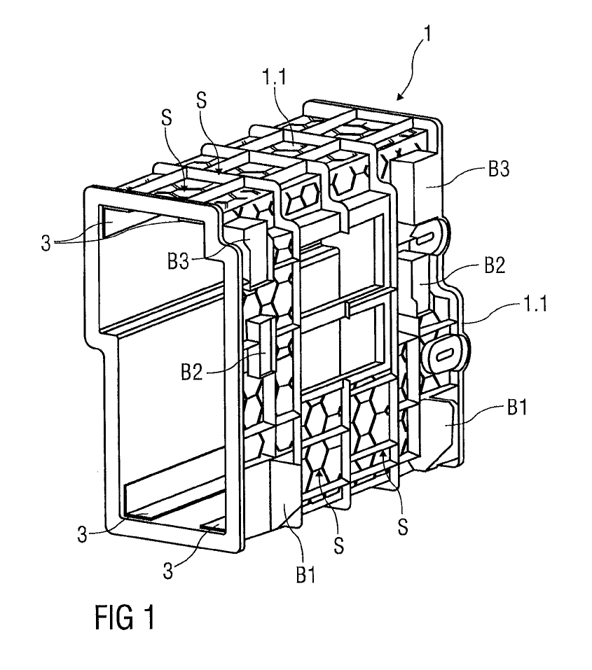

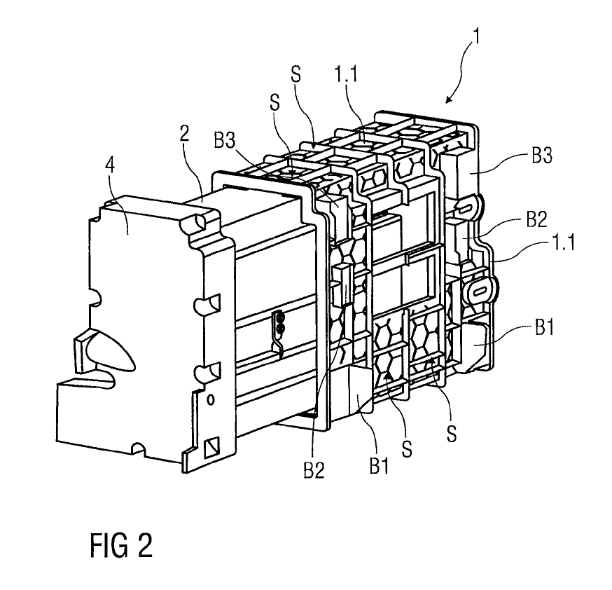

FIG. 1 shows a perspective view of a housing 1 for a fuel cell stack 2 partially illustrated in FIG. 2. The fuel cell stack 2 is a component of a fuel cell system, by means of which electrical energy is generated which is converted into kinetic energy. Such a fuel cell system is preferably disposed in a vehicle or a transport means.

The housing 1 is substantially box-shaped and has an open side into which the fuel cell stack 2 can be inserted when the latter is disposed in the housing 1, as FIG. 2 shows.

In order to ensure that the housing 1 has a comparatively low weight, the housing 1 is produced as a so-called lightweight construction. To this end the housing 1 is made of metal, for example of an aluminum and/or a magnesium alloy, and/or of fiber-reinforced plastic, such as for example a carbon fiber-reinforced plastic and/or a carbon fiber-reinforced carbon.

As described above, the fuel cell stack 2 is disposed in the housing 1, and walls 1.1 of the housing 1 have a reinforcing structure S for increasing the protective effect for the fuel cell stack 2. The walls 1.1 arc stiffened by means of the reinforcing structure S, so that the housing 1 is designed to be more stable, in particular with respect to deformations.

To this end the reinforcing structure S is formed as ribs which are cuboid and honeycomb-shaped on the respective wall 1.1 of the housing 1. The ribs which are designed to form a cuboid shape on the wall 1.1 have larger dimensions than the ribs which form the honeycomb shape. As a result the ribs of the cuboid shapes project over the ribs which are disposed in a honeycomb shape.

Additionally or alternatively the reinforcing structure S can have different shapes, and it may also be provided that one or more separate reinforcing elements (not shown) is or are fastened to one or more walls 1.1 of the housing 1.

Moreover guide elements 3 which simplify the insertion of a fuel cell stack 2 can be disposed in the interior of the housing 1 in the corner regions. The guide elements 3 can be made of an electrically insulating material, such as for example an electrically insulating plastic. This improves the electrical insulation of the fuel cell stack 2 and is particularly advantageous when the housing 1 is made of a metal or another electrically conductive material.

The housing 1 serves in particular for protecting the fuel cell stack 2 and forms the support structure thereof.

Moreover it is possible to insulate the fuel cell stack 2 both electrically and also thermally, wherein with regard to electromagnetic compatibility the fuel cell stack 2 is electronically shielded from its surroundings by means of the housing 1 and as a result fire protection can also be increased.

In order to form an insulating section, in particular as contact protection, the housing 1 is preferably designed to be electrically insulated at least in some sections, wherein such sections are preferably characterized so that when handling the housing 1 with the fuel cell stack 2 a person is made aware of a possible danger.

Furthermore by means of the housing 1, in particular due to the structure S which reinforces the walls 1.1, the fuel cell stack 2 is substantially protected against deformation in the event of intrusion into the vehicle due to collision. Thus the housing 1 constitutes a mechanical protection for the fuel cell stack 2. In the event of acceleration due to collision, a reduced or optimized introduction of force takes place by means of the housing 1, for example by a formed so-called fixed/free bearing and/or a flexible support in the housing 1, at least in the fuel cell stack 2.

It is also possible for the housing 1 to be used for integration of functions of the fuel cell system, such as for example a ventilation function for pressure reduction, a drainage function and/or as an insulating section. The material for production of the housing 1 is selected according to the required function to be integrated, the housing 1 preferably being designed in sealed form. For this purpose it may also be provided that the housing 1 is formed of a plurality of materials, so that the housing 1 is thermally and/or electrically insulated at least in some sections.

Further fuel cell system components can be disposed in the housing 1 and are preferably thermally coupled to the fuel cell stack 2, so that a cold starting capability of the fuel cell system is improved.

Fastening points B1 to B3 which serve for fastening of fuel cell system components (not shown in greater detail) are formed on the walls 1.1 in the region of the reinforcing structure S. For example a compressor, a moistening device, a current supply unit (power distribution unit), an ion exchanger, a particle filter, valves, an electric turbocharger (ETC) including associated electronics, a heat exchanger and/or the like can be provided as fuel cell system component or components at the fixing points B1 to B3. In the present embodiment according to FIG. 1 the fastening points B1 to B3 are formed on a wall 1.1 of the housing 1 which has a large surface area.

Within the scope of the present invention the fuel cell system components which can be fastened to the housing 1 also include components of the drive train of a fuel cell vehicle (vehicle having an electric drive, of which the electrical drive energy is generated at least partially by a fuel cell stack). These drive train components include inter alia the electric drive motor, the power electronics, a vacuum pump of the brake system, parts of any air conditioning system, sound absorber, filter housing and/or the like.

First fastening points B1 are designed as lug-like formations which project from the wall 1.1 and onto which at least one fuel cell system component can, for example, be fitted, so that the fuel cell system component can be fastened to the housing 1 by positive engagement.

It is also conceivable that the first fastening points B1 in the form of the lug-like formations have through holes in which in each case a fastening element, in particular a screw, can be disposed, so that the fuel cell system component can be alternatively or additionally fastened to the housing 1 by non-positive engagement.

Again additionally or alternatively the respective fuel cell system component can also be fastened to the first fixing points B1 by cohesive bonding.

Second fastening points B2 on the wall 1.1 of the housing 1 are designed in a similar way to the cuboid-shaped ribs of the reinforcing structure S. As a result the second fastening points B2 form a frame, wherein the elements forming the shape of the frame project over the reinforcing structure S of the wall 1.1.

At least one fuel cell system component can be clamped and/or inserted and/or fastened in some other way, such as also by non-positive engagement and/or by cohesive bonding, on the second fastening point B2.

Third fastening points B3 are likewise formed on the wall 1.1 as so-called slots for fastening of fuel cell system components by positive engagement, wherein it is possible, for example by means of suitable aids, to fasten the respective fuel cell system component additionally or alternatively by non-positive engagement and/or by cohesive bonding to the third fixing points B3.

For example in each case a fuel cell system component can be fastened to both respective fastening points B1 to B3 or in each case a system component can be fastened to a fastening point B1 to B3.

The fastening points B1 to B3 may also have other suitable shapes, wherein the fastening points B1 to B3 are always formed in the region of the reinforcing structure S of the respective wall 1.1 of the housing 1.

One or more of the fastening points B1 can be provided in a possible configuration for fastening of the housing 1 in the installation space provided therefore, so that the fastening point(s) B1 to B3 serve as bearing points for the housing 1.

By means of the fastening points B 1 to B3 different fuel cell system components can be fastened to the housing 1 so that the fuel cell system is at least in part of compact construction and no further installation space is necessary for arrangement of fuel cell system components.

Since the housing 1 has a plurality of fastening points B1 to B3 which can also be used as bearing points, the housing 1 with fuel cell stack 2 and fuel cell system components can be flexibly fastened in an available installation space.

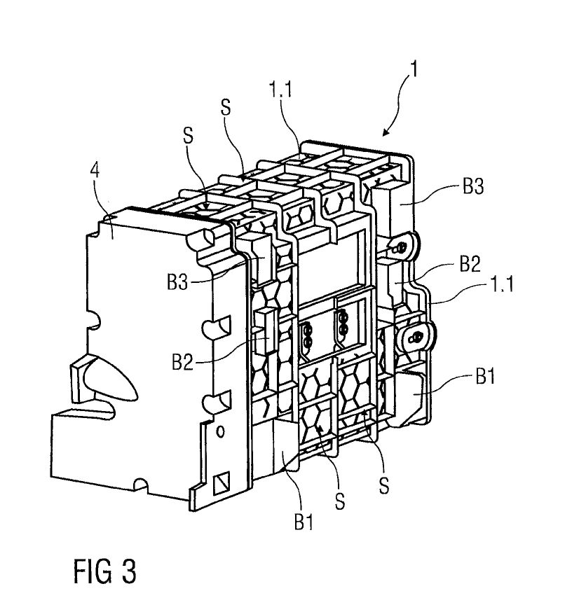

In FIG. 2 the fuel cell stack 2 partially inserted into the housing 1 is illustrated in a perspective view, the housing 1 being shown in the closed state in FIG. 3.

A housing cover 4 for sealed closure of the housing 1 is disposed on the fuel cell stack 2 and is preferably fastened at least by positive engagement. To this end a peripheral seal can be disposed between the housing 1 and the housing cover 4 in order to make the housing 1 extremely fluid-tight.

Further components of the fuel cell system are preferably integrated in the housing cover 4, so that optimal use is made of the installation space provided by means of the housing cover 4. For example, devices for hydrogen preconditioning and/or for conveying media and/or sensor connection points for media measurement can be integrated in the housing cover 4 as further components. These devices themselves may form further attachment points for fuel cell system components.

Furthermore the housing cover 4 may have further fastening points formed for arrangement of fuel cell system components.

The housing cover 4 is made of a material which is suitable to meet requirements, such as for example for electrical and/or thermal insulation. The housing cover 4 can also be made of different materials, so that the housing cover 4 insulates electrically, for example at least in some sections, in order to continue the insulating section of the housing 1.

A uniform temperature distribution prevails in the housing 1 which is closed by means of the housing cover 4, so that the ventilation function of the housing 1 is optimized for equalizing the pressure. Due to the uniform temperature distribution it may additionally be ensured that few condensation problems occur in the media-conveying and ventilating region. The conveying of media inside the housing 1 and/or the housing cover 4 can be implemented with flexible cross-sectional geometries, so that the necessary installation space can be reduced.

The ventilating region and the drainage region necessary in particular for the hydrogen concentration and the moisture content are formed between the fuel cell stack 2 and the housing 1, the ventilation function being improved due to the uniform temperature distribution in the housing 1.

Fuel cell system components disposed within the housing 1 are preferably thermally coupled to the fuel cell stack 2, so that the hydrogen can be preconditioned. Furthermore the cold starting capability of the fuel cell system is improved by the thermal coupling.

The housing 1 with the housing cover 4 forms a multifunction component for a fuel cell system, wherein, by means of a fuel cell stack 2 designed in such a way, during the production of the fuel cell system savings can be made on costs, weight, installation space, the number of components and therefore the installation time.

Due to the differently designed fastening points B1 to B3 disposed on the corresponding wall 1.1 as bearing points it is possible to install the housing 1 in various available installation spaces.

By means of the housing 1 closed by means of the housing cover 4 a plurality of necessary functions with regard to the fuel cell stack 2 and thus also with regard to the fuel cell system can be simplified, particularly since the housing 1 constitutes a compact structural unit of the fuel cell system.

In one possible embodiment a higher pressure may prevail in the housing 1 by comparison with the surroundings, so that it is possible to compensate for an internal pressure in the fuel cell stack 2.

The closable housing 1 is a comparatively small compact space-saving design for a fuel cell system, wherein the housing 1 simultaneously fulfils several of the functions described above.

### LIST OF REFERENCE NUMBERS

1 housing
1.1 wall
2 fuel cell stack
3 guide elements
4 housing cover
B1 first fastening points
B2 second fastening points
B3 third fastening points
S reinforcing structure

1-10. (canceled)

11. A housing for a fuel cell stack, comprising:
a wall, wherein the wall has a reinforcing structure in a region of the wall, wherein in the region of the wall with the reinforcing structure a fastening point is formed, and wherein a fuel cell system component is fastenable on the fastening point and/or the housing is supportable in an installation space by the fastening point.

12. The housing according to claim 11, wherein the reinforcing structure is formed as ribs having a honeycomb shape and/or a square shape.

13. The housing according to claim 11, wherein the fastening point is a formation projecting from the wall.

14. The housing according to claim 11, wherein a fastening element is disposed on the fastening point.

15. The housing according to claim 11, wherein the housing is made of metal and/or a fiber-reinforced plastic.

16. The housing according to claim 11, wherein the housing is closable by a housing cover and wherein a device of a fuel cell system is integrated in the housing cover.

17. The housing according to claim 16, wherein the housing cover has a second fastening point and wherein a second fuel cell system component is fastenable on the second fastening point.

18. The housing according to claim 16, wherein the wall and/or the housing cover is electrically insulating at least in sections.

19. The housing according to claim 16, wherein the wall and/or the housing cover is thermally insulating at least in sections.

20. The housing according to claim 11 in combination with a fuel cell stack, wherein the fuel cell stack is disposed in the housing and wherein fuel cell system components disposed in the housing are thermally coupled to the fuel cell stack.
